(19) United States
(12) Patent Application Publication
(10) Pub. No.: US 2014/0164109 A1
(43) Pub. Date: Jun. 12, 2014

(54) INTELLIGENT PROVISIONING OF OFFERS

(71) Applicants: Jing-Ta Chow, Boston, MA (US); Michael Macasek, Cambridge, MA (US)

(72) Inventors: Jing-Ta Chow, Boston, MA (US); Michael Macasek, Cambridge, MA (US)

(73) Assignee: eBay Inc., San Jose, CA (US)

(21) Appl. No.: 13/712,283

(22) Filed: Dec. 12, 2012

(51) Int. Cl. G06Q 30/02

(52) U.S. Cl. CPC G06Q 30/0255
USPC 705/14.53

(57) ABSTRACT

A method of intelligent provisioning of offers is provided. Merchant information for a merchant is received. Then one or more attributes of one or more user cluster groups are retrieved from a user cluster group service, the user cluster groups including groupings of users from previously recorded transactions. One or more metrics can then be calculated from the one or more attributes. The user cluster groups can then be ranked based on the one or more metrics. An advertising campaign can then be automatically provisioned based on the ranking of the one or more user cluster groups and based on the merchant information.

### TECHNICAL FIELD

This application relates generally to data processing within a network-based customer valuation and merchant bidding system over a distributed network, and more specifically to systems and methods for intelligently provisioning offers in such a system.

### BACKGROUND

The explosion of information available over network-based systems, such as the Internet, can overwhelm a business that is attempting to decide which customers or segments of the customer population to approach and/or contact regarding advertising or promotions. For example, a business that is looking to provide coupons or other promotions to potential customers may provide such coupons or promotions to the potential customers via a mass mailing, either paper-based or electronic-based. However, such a mass mailing is not targeted at all, and many such coupons or promotions will land in the mailboxes of persons who have no intention of purchasing the business's products or services, or have no intention of ever traveling to the area in which the business is located.

### BRIEF DESCRIPTION OF DRAWINGS

FIG. 1 is a network diagram depicting a client-server system, within which one example embodiment may be deployed.

FIG. 2 is a block diagram illustrating multiple applications and that, in one example embodiment, are provided as part of the networked system

FIG. 3 is a diagram illustrating a system, in accordance with an example embodiment, of intelligently provisioning offers.

FIG. 4 is an interaction diagram illustrating a method, in accordance with an example embodiment, of intelligently provisioning offers.

FIG. 5 is a flow diagram illustrating a method, in accordance with an example embodiment, of intelligently provisioning offers.

FIG. 6 is a block diagram of a machine in the form of a computer system within which a set of instructions for causing the machine to perform any one or more of the methodologies discussed herein may be executed.

### DETAILED DESCRIPTION

Example systems and methods for providing customer valuation and receiving merchant offers for advertising or other campaigns are described. In an example embodiment, such customer valuation and merchant bidding occur in real time or near real time. The systems and methods for providing the customer valuation and receiving the merchant offers, in some example embodiments, may provide the valuation and bidding based on present and/or past behavior of a customer or other user interacting with a network-based system, such as a network-based location-aware system, or it could be based on a customer or other user accessing the Internet, and in particular, a web-site of a merchant. In the following description, for purposes of explanation, numerous specific details are set forth in order to provide a thorough understanding of example embodiments. It will be evident, however, to one skilled in the art that embodiments may be practiced without these specific details. It will also be evident that customer valuation and merchant bidding are not limited to the examples provided herein, and may include other scenarios not specifically discussed.

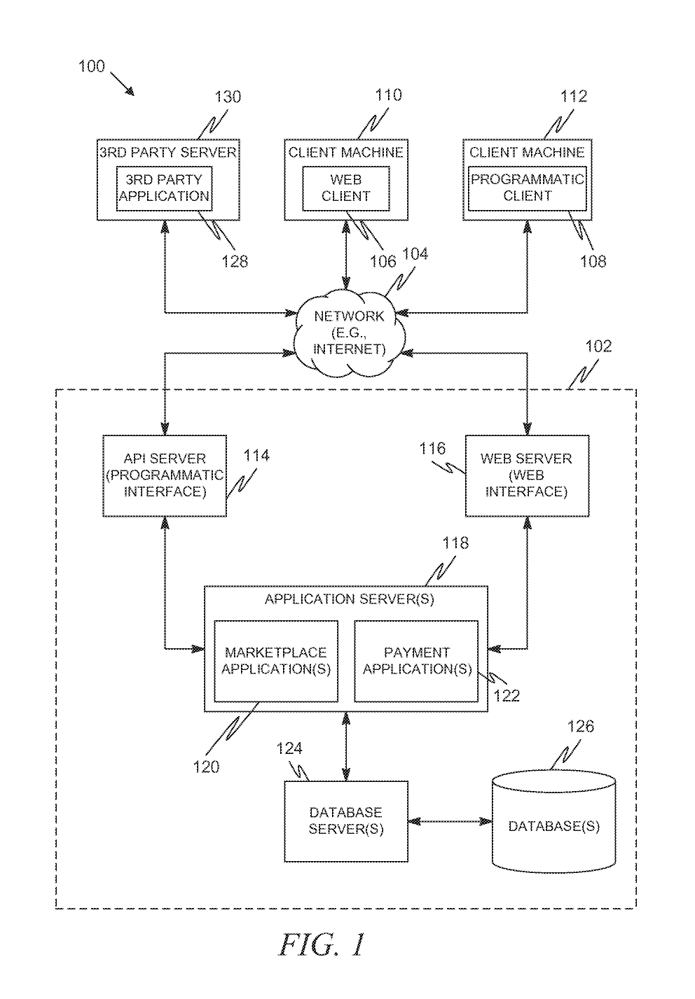

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients, FIG. 1 illustrates, for example, a web client 106 (e.g., a browser, such as the Internet Explorer browser developed by Microsoft Corporation of Redmond, Wash.) and a programmatic client 108 executing on respective client machines 110 and 112,

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

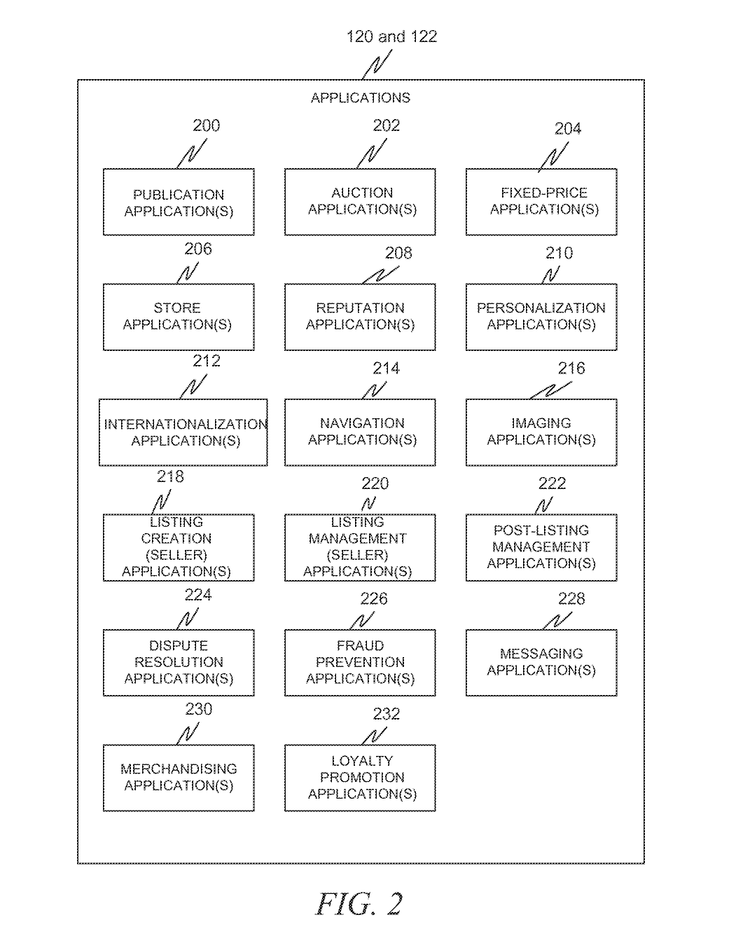

FIG. 2 is a block diagram illustrating marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria e.g., geographic, demographic or marketplace criteria For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102, Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message GM), Short Message Service (SMS), text, facsimile, or voice (e.g., Voice over IP (VoIP)) messages via the wired (e.g., the Internet), Plain Old Telephone Service (POTS), or wireless (e.g., cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

As described briefly earlier, in an example embodiment, information about customers can be gathered and used to aid in provisioning offers for advertising and other campaigns. In an example embodiment, this information about customers may be gathered from the above-described systems. Clustering may take place to organize the information, which may be stored in customer and transaction databases.

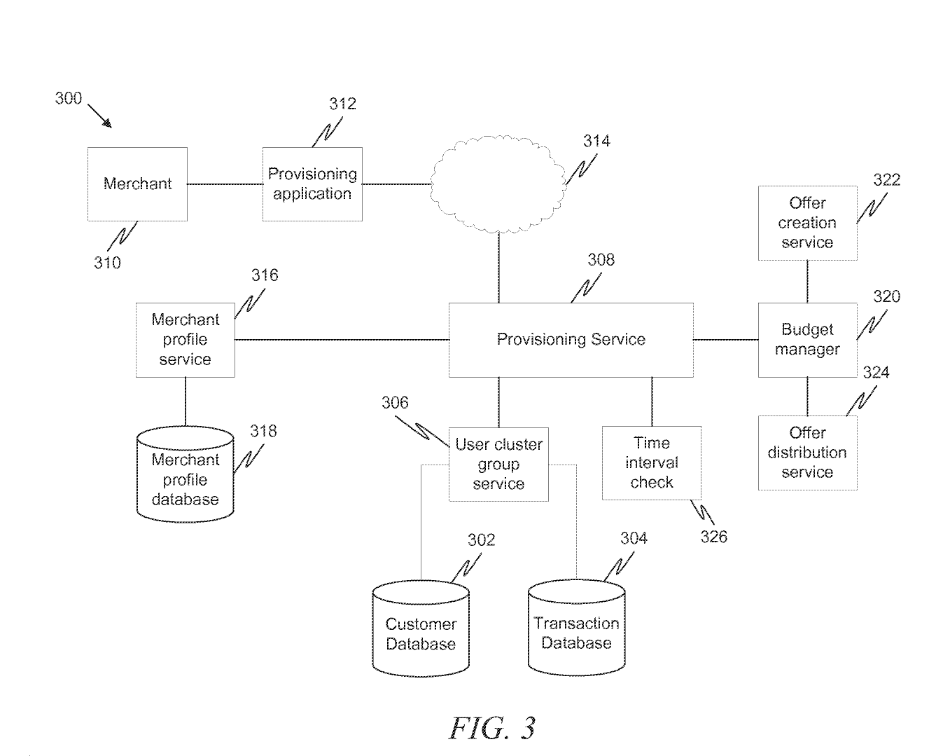

FIG. 3 is a diagram illustrating a system, in accordance with an example embodiment, of intelligently provisioning offers. In the system 300, transaction information from customers may be stored in a transaction database 304. Additional customer information, such as customer name and profile information, can be stored in a customer database 302. A user cluster group service 306 may act to cluster the information from the transaction database 304 and customer database 302. The user cluster group service 306 may identify user cluster groups, using a technique such as centroid clustering, which may utilize a k-means or distribution clustering method to cluster transactions into predefined customer segments. Through this process, the following attributes may be computed for each user cluster group:
(1) average transaction value
(2) average total lifetime spend
(3) average future spend
(4) cost to acquire
(5) potential candidates (via migration path)
(6) migration path

Migration path is a distance or likelihood to convert another user cluster group (i.e., the risk of devolving or the potential to evolve behavior based on transaction patterns). The user duster groups may then be ranked with the highest future spending/profit compared to the cost to acquire. These groups are the groups first looked for to grow, in order. At some point, the group with greatest value versus cost will be new users.

In an example embodiment, a provisioning service 308 may then utilize the above attributes to compute one or more metrics for each user cluster group. These metrics may include average transaction value, average transaction count, and number of new users. It should be noted that in some embodiments these metrics may be performed by the user cluster group service 306. Offers can then be provisioned to either increase average transaction value (such as by offering a percentage off, or free money for a minimum spend), increase average transaction count (such as an incentive after n transactions or n offers delivered in the style of a coupon booklet), and increasing new users (such as by rewards for sharing on social channel, bringing guests, or giving one time discounts). This allows each offer to identify the number of users it can target, and the likelihood of moving users into a more valuable segment. The system 300 can also opt to stabilize a sustaining budget model to keep multiple campaigns alive concurrently by dividing the budget intelligently and assigning percentage allocations to individual groups to maximize their value and consistency. A portion of budget could be allocated to “swing”, where it can be assigned as outlined above.

A merchant 310 seeking to start or modify a campaign can access a provisioning application 312, which interfaces with the provisioning service 308. In an example embodiment, the provisioning application 312 is located on a user device, such as a mobile device or desktop computer, while the provisioning service 308 resides on a server. In the depicted example embodiment, a network 314 such as the Internet separates the provisioning application 312 from the provisioning service 308. A merchant profile service 316 may create a profile for the merchant 310, which is then stored in the merchant profile database 318. This merchant profile is utilized by the provisioning service 308 to match a campaign type with the merchant's needs. A budget manager 320 can, as mentioned before, manage the budget for the campaign (along with the budgets for other campaigns) in order to maximize the effectiveness of the campaign. Once budgets are assigned to each campaign, an offer creation service 322 may create the offers (e.g., formulate emits, create advertisements or coupons, etc.), while an offer distribution service 324 distributes the offers, such as by sending out the offers electronically (e.g., entails, text messages), coordinating with third parties to distribute advertisements (either electronically, such as online or in applications, or physically, such as in print, radio, or television), and any oilier distribution mechanisms dictated by the chosen campaign(s).

Periodically, a time interval check module 326 may force the provisioning service 308 to reevaluate the offers, in case new information about the users gathered by the user cluster group service 306 would dictate a modification of exiting offers or the formation of new offers.

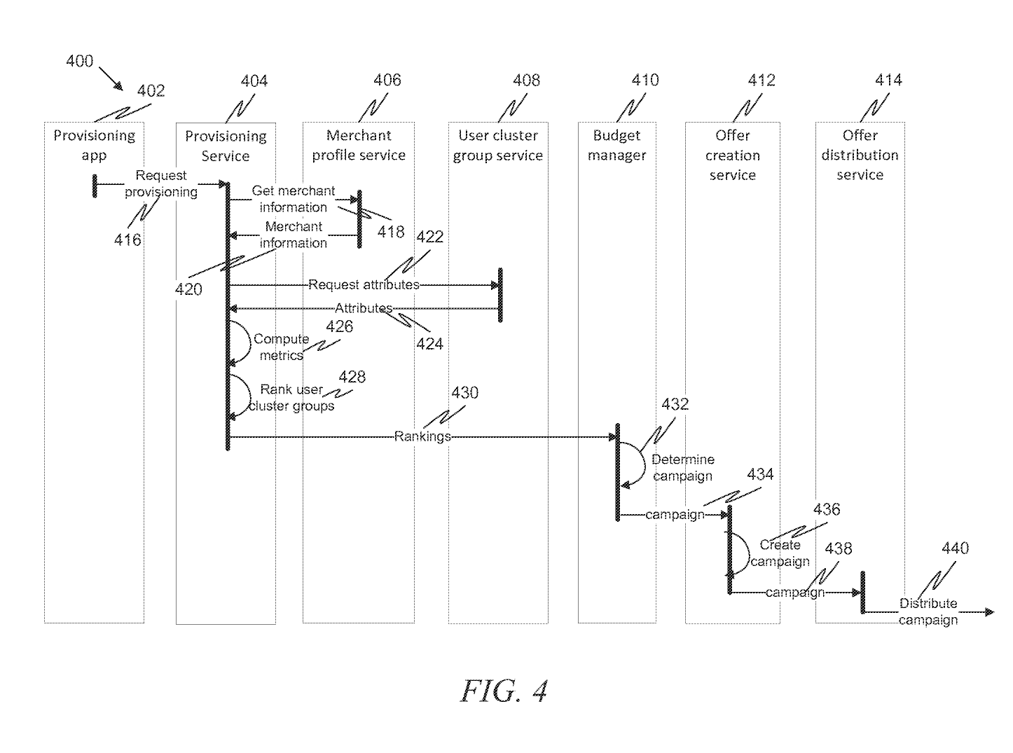

FIG. 4 is an interaction diagram illustrating a method, in accordance with an example embodiment, of intelligently provisioning offers. The method 400 may involve a series of components, including a provisioning application 402, provisioning service 404, merchant profile service 406, user cluster group service 408, budget manager 410, offer creation service 412, and offer distribution service 414. At operation 416, provisioning application 402 requests that an offer be provisioned. At operation 418, the provisioning service 404 interfaces with merchant profile service .406 to obtain merchant information for a merchant corresponding to the provisioning application. At operation 420, the merchant information is returned. The mechanism by which the provisioning service 404 can identify the merchant to the merchant profile service 406 can vary greatly by implementation. In an example embodiment, the provisioning service 404 receives a merchant identifier from the provisioning application 402, and this merchant identification is passed at operation 418 to the merchant profile service 406. The merchant identification may be specified by the merchant by, for example, entering a user identification in the provisioning application 402.

At operation 422, the provisioning service 404 retrieves user cluster group information from the user cluster group service 408. The user cluster group information can include various attributes of each user duster group. It may be assumed that the user cluster group service 408 gathered these attributes from a customer and/or transaction database prior to receiving the request at operation 422, but in some example embodiments the user cluster group information may be gathered and computed in real time when prompted at operation 422. Nevertheless, at operation 424, the attributes are returned to the merchant profile service 406. At operation 426, metrics may be computed for each user cluster group, based on the attributes. At operation 428, the user cluster groups may be ranked by the metrics. Specifically, a different ranking may be computed for each of the metrics. This is because, as described earlier, different metrics can indicate different types of campaigns to target. Specifically, in one example embodiment, the user cluster groups are ranked by average transaction value, average transaction count, and number of new users.

At operation 430, the rankings are transmitted to the budget manager 410. At operation 432, the budget manager 410 determines how best to distribute available funds for the merchant based on the rankings. The budget manager 410 may retrieve information about available funds from the merchant profile service 406. In one example embodiment, polynomial equations may be used to determine the best match of campaigns for the available budget, based on the rankings. At operation 434, the determined campaigns are passed to an offer creation service 412, which creates the campaigns at operation 436. At operation 438, the determined campaigns are then sent to the offer distribution service 414 for distribution, which occurs at operation 440.

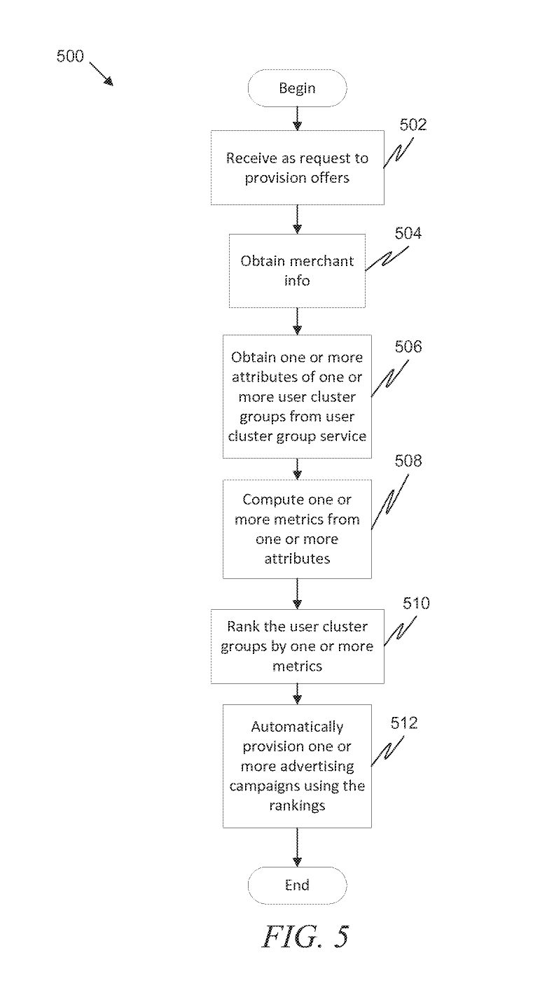

FIG. 5 is a flow diagram illustrating a method, in accordance with an example embodiment, of intelligently provisioning offers. This method may be performed, for example, at a provisioning service. The method 500 may be begin at operation 502, where a request to provision offers may be received from a provisioning application, the request to provision offers including an identification of a merchant for which the offers should be provisioned. At operation 505, merchant information may be obtained from a merchant profile service. At operation 506, one or more attributes of one or more user cluster groups may be obtained from a user cluster group service. The user cluster groups may be groupings of previous transaction information from users. At operation 508, one or more metrics may be computed from the one or more attributes. At operation 510, the user cluster groups may be ranked by the one or more metrics. At 512, one or more advertising campaigns may be automatically provisioned for the merchant using the rankings. This automatic provisioning may, for example, take into account a predefined budget for the merchant (identified in the merchant information), as well as advertising campaign cost information. Specific goals for the merchant may also be estimated based on the merchant information from the merchant profile service, such as from a description of the area of business of the merchant (which can be compared to effective campaigns of other merchants in that area of business).

As an example, a boutique store may have a budget of $10,000.00 to increase sales. The system may identify five primary segments of customers, based on previous campaigns for boutique stores: (1) people who are not aware of the store, (2) people who have purchased only once from the boutique store , at an average of $100-$500, (3) people who have purchased an average of $100-$400 twice a year from the store, (4) people who have purchased an average of $500-$1000 three times a year from the store, and (5) people who have purchased $200-$400 about twelve times a year from the store.

The system may recognize that the highly engaged customers who purchase twelve times a year are the most valuable, but the number of available candidate customers is small. The system determines, therefore, it is best to grow the twice a year purchaser segment, which may have a large available candidate pool and a low cost to convert, and to do so will engage the one time purchaser group to attempt to get them to convert into the twice a year purchaser segment.

The system may then identify the most likely advertising campaign (e.g., offer) to convert a one-time purchaser to a two-time purchaser, by examining the spending habits of the twice-a-year purchaser and determining that people who spend more than $200 on their first purchase tend to spend as much if not more on their next purchase, provided it happens at least four months apart. The system then can create a targeted offer for people who purchased 4 months or longer ago that grants a fixed discount of $20 off as an initial measurement campaign using a small percentage of the budget, for example 20% of the budget (allowing for 1000 offers at $20 a piece). After running for a fixed time, for example 3 weeks, the campaign may have brought in repeat customers, but they were spending only about $100 on average. The system can then reanalyze the customer segments and ends at the same conclusion as it did previously, except now it knows that customers tend to spend less when given a fixed discount at this store. While a $100 sale is profitable, a customer is more likely to move up the chain by spending over $200, so the campaign is reconfigured to provide 20% off a second purchase instead of $20. The cycle can continue to repeat while budget is remaining, each time learning more and more about the user spending habits and responsiveness to offers as time goes on.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

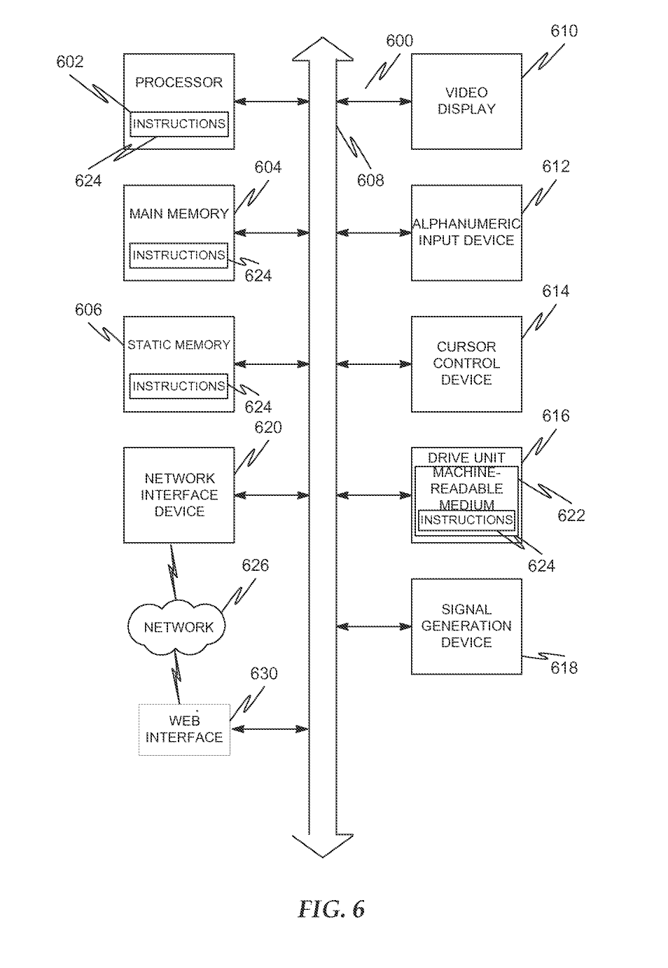

FIG. 6 is a block diagram of a machine in the form of a computer system within which a set of instructions may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In one embodiment, the machine will be a server computer; however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a display unit 610, an alphanumeric input device 612 (e.g., a keyboard), and a user interface (111) navigation (e.g., cursor control) device 614 (e.g., a mouse). In one embodiment, the display, input device 612 and cursor control device 614 are a touch screen display. The computer system 600 may additionally include a storage device (e.g., drive unit) 616, a signal generation device 618 (e.g., a speaker), a network interface device 620, and one or more sensors (not pictured) such as a global positioning system sensor, compass, accelerometer, or other sensor.

The drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the embodiments of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and MID-ROM disks.

The instructions 624 may further be transmitted or received over a communications network 626 using a transmission medium via the network interface device 620 utilizing any one of a number of welt-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A system comprising:
a processor;
a memory; and
a provisioning service configured to:
obtain merchant information for a merchant;
obtain one or more attributes of one or more user cluster groups from a user cluster group service, the user cluster groups including groupings of users from previously recorded transactions;
calculate one or more metrics from the one or more attributes;
rank the one or more user cluster groups based on the one or more metrics; and
automatically provision an advertising campaign based on the ranking of the one or more user cluster groups and based on the merchant information.

2. The system of claim 1, wherein the previously recorded transactions include transactions involving purchases made at the merchant.

3. The system of claim 2, wherein the one or more metrics include average transaction cost.

4. The system of claim 2, wherein the one or more metrics include average transaction count.

5. The system of claim 1, wherein the merchant information includes a budget.

6. The system of claim 1, wherein the user cluster groups are clustered using centroid clustering.

7. The system of claim 6, wherein the centroid clustering involves a k-means method.

8. The system of claim 6, wherein the centroid clustering involves a distribution clustering method.

9. A method comprising:
receiving merchant information for a merchant;
obtaining one or more attributes of one or more user cluster groups from a user cluster group service, the user cluster groups including groupings of users from previously recorded transactions;
calculating one or more metrics from the one or more attributes;
ranking the one or more user cluster groups based on the one or more metrics; and
automatically provisioning an advertising campaign based on the ranking of the one or more user cluster groups and based on the merchant information.

10. The method of claim 9, wherein the one or more attributes include average transaction value.

11. The method of claim 9, wherein the one or more attributes include average total lifetime spending.

12. The method of claim 9, wherein the one or more attributes include average future spending.

13. The method of claim 9, wherein the one or more attributes include cost to acquire.

14. The method of claim 9, wherein the one or more attributes include potential candidates.

15. The method of claim 9, wherein the one or more attributes include migration path.

16. The method of claim 9, wherein the method is performed at a provisioning service on a server.

17. The method of claim 9, wherein the merchant information includes a merchant identification.

18. The method of claim 17, further comprising passing the merchant identification along with the automatically provisioned advertising campaign to a budget module.

19. A non-transitory computer-readable storage medium comprising instructions that, when executed by at least one processor of a machine, cause the machine to perform:
receiving merchant information for a merchant;
obtaining one or more attributes of one or more user cluster groups from a user cluster group service, the user cluster groups including groupings of users from previously recorded transactions;
calculating one or more metrics from the one or more attributes;
ranking the one or more user cluster groups based on the one or more metrics; and
automatically provisioning an advertising campaign based on the ranking of the one or more user cluster groups and based on merchant information.

20. The non-transitory computer-readable storage medium of claim 19, wherein the non-transitory computer-readable storage medium further causes the machine to perform:
passing the merchant identification along with the automatically provisioned advertising campaign to a budget module.
